(19) United States
(12) Patent Application Publication
(10) Pub. No.: US 2009/0026347 A1
(43) Pub. Date: Jan. 29, 2009

(54) TAXIDERMY MOUNTING TOOL AND METHOD

(76) Inventor: Michael A. Noon, Carey, OH (US)

Correspondence Address: FRASER CLEMENS MARTIN & MILLER LLC, 28366 KENSINGTON LANE, PERRYSBURG, OH, 43551, US

(21) Appl. No.: 12/178,762

(22) Filed: Jul. 24, 2008

Related U.S. Application Data
(60) Provisional application No. 60/951,545, filed on Jul. 24, 2007.

(51) Int. Cl. A47F 5/00; G09B 23/36; B44C 5/02

(52) U.S. Cl. 248/684; 434/296; 248/309.2; 248/216.4

(57) ABSTRACT

A taxidermy mounting tool an apparatus for performing a taxidermy procedure is disclosed, wherein the taxidermy mounting tool includes a plug adapted to be disposed in an aperture formed in the mannikin and formed on an end of a means for posing.

### CROSS-REFERENCE TO RELATED APPLICATION

This application claims the benefit of U.S. Provisional Patent Application Ser. No. 60/951,545 filed Jul. 24, 2007, hereby incorporated herein by reference in its entirety.

### FIELD OF THE INVENTION

The invention relates Lo taxidermy, and more particularly to a method and apparatus for anchoring a specimen to a mannikin to allow a taxidermist to pose the specimen prior to permanent mounting thereof.

### BACKGROUND OF THE INVENTION

Taxidermy is the art of mounting or reproducing animals for display as hunting trophies or for study. All species of animal may be mounted or reproduced using taxidermy. The goal of taxidermists is to produce attractive, life-like animal displays.

Typically, taxidermy specimens are preserved by freezing the specimen until the taxidermist begins the mounting procedure. To begin the mounting procedure, the taxidermist removes the skin from the specimen so that it may be chemically preserved or tanned and treated for later use. The remaining muscle, fibers, and bones of the specimen are measured and manipulated to determine the proper pose for the finished mount. A mold is then formed in plaster from the carcass of the specimen. The mold is used to produce a cast of the animal, known as a mannikin. Sculpted clay may also be used to form the mannikin.

Further, stock mannikns formed from polyurethane foam or other similar materials, in numerous shapes and sizes, are commercially available.

Glass eyes and artificial teeth, if the original teeth are damaged or missing, are then attached to the mannikin to give the final mount more realistic facial detail. For example, glass eyes may be set into the mannikin and then clay may be added to recreate the proper eyelid and muscle definition of the specimen. Other mannikins use preformed eye capsules which must be adhered to the mannikin. The skin is placed over the mannikin, and stuffing, such as cotton, polyester fiber, or other material, is placed between the mannikin and the skin. The stuffing is placed between the mannikin and the skin in varying amounts to represent musculature, connecting tissue, and other contours of the animal.

Once the skin is in place, wires, rods, or other pliable structures are used to mount the head and neck, arms, legs, tall, and other appendages of the specimen Lo the mannikin. The wire is mounted to the mannikin by forcibly pushing the wire into the mannikin through the outer walls thereof. The pliable structures provide support to the appendage and allow for the posing of the specimen in a desired manner. The pliable structure must be manipulated carefully to avoid puncturing the skin or otherwise damaging the specimen. Further, if the wires are mounted too deeply into the mannikin, the skin must be removed, the wires forcibly removed from the mannikin and the specimen remounted. Removal of the wires from the mannikin may damage the mannikin thereby requiring repairs or the production of a new mannikin.

It would be desirable to develop a taxidermy mounting tool and method for removably anchoring a specimen to a mannikin to allow a taxidermist to more easily to pose the specimen prior to permanent mounting.

### SUMMARY OF THE INVENTION

Concordant and congruous with the present invention, a taxidermy mounting tool and method for removably anchoring a specimen to a form to allow a taxidermist more easily to pose the specimen prior to permanent mounting has surprisingly been discovered.

In an embodiment of the invention, a taxidermy tool for mounting a mannikin comprises a support means for posing having spaced apart ends; and a plug formed at one end of said support means adapted to be received in an aperture formed in a mannikin, wherein said support means may be selectively manipulated to obtain a desired orientation.

In another embodiment of the invention, a taxidermy tool for mounting a mannikin comprises a support means for posing the mannikin having spaced apart ends; a plug formed at one end of said support means adapted to be received in an aperture formed in the mannikin; and at least one anchor formed on said plug and adapted to militate against the relative rotation of said plug in the aperture, wherein said support means may be selectively manipulated.

In another embodiment of the invention, a method of performing a taxidermy procedure comprises the steps of: providing a mannikin of a desired specimen having at least one aperture formed therein; providing a taxidermy mounting tool including a support means the mannikin with a plug disposed on an end thereof; disposing the skin of the specimen over the mannikin; disposing one of a neck, a leg, an arm, and a tail over the support means of the taxidermy mounting tool; manipulating the support means to obtain a desired orientation of one of the neck, the leg, the arm, and the tail; disposing the plug of the taxidermy mounting tool in the aperture of the mannikin; adjusting the taxidermy mounting tool to obtain the desired pose of the specimen; and fixing the plug in the aperture of the mannikin to maintain the desired pose.

### BRIEF DESCRIPTION OF THE DRAWINGS

The above and other objects and advantages of the invention will become readily apparent to those skilled in the art from reading the following detailed description of the invention when considered in the light of the accompanying drawings, in which:

FIG. 1 is a perspective view of a taxidermy mounting tool in accordance with an embodiment of the invention;

FIG. 2 is a perspective view of a taxidermy mounting tool in accordance with another embodiment of the invention;

FIG. 3 is a perspective view of a taxidermy mounting tool in accordance with another embodiment of the invention;

FIG. 4 is a perspective view of a taxidermy mounting tool in accordance with another embodiment of the invention;

FIG. 5 is a perspective view of a taxidermy mounting tool in accordance with another embodiment of the invention;

FIG. 6 is a perspective view of a taxidermy mounting tool n accordance with another embodiment of the invention;

FIG. 7 is an elevational view partially in section of a mounted duck including a duck mannikin including the mounting tool of FIG. 1 to anchor the head of the mounted tuck to the mannikin and a plurality of apertures adapted to receive the desired taxidermy mounting tools shown in FIGS. 1-6;

FIG. 8 is a side elevational view of a turkey mannikin having a plurality of apertures adapted to receive the desired taxidermy mounting tools shown in FIGS. 1-6;

FIG. 9 is an elevational view of a mounted bird in a flying pose mounted to a wall and supported by a the taxidermy mounting tool of FIG. 6;

FIG. 10 is an elevational view of a mounted fish supported by a plurality of taxidermy mounting tools shown in FIG. 3;

FIG. 11 is a perspective view of a base mounted bird supported by a taxidermy mounting tools shown in FIG. 2;

FIG. 12 is a perspective view of a ceiling mounted bird hung by a plurality of the taxidermy mounting tools shown in FIG. 5;

FIG. 13 is a side elevational view of a squirrel mannikin including a plurality of the taxidermy mounting tools shown in FIG. 1;

FIG. 14 is a side elevational view of a deer pedestal mannikin incorporating the taxidermy mounting tool shown in FIG. 3; and

FIG. 15 is a perspective view of a taxidermy mounting tool in accordance with another embodiment of the invention

### DETAILED DESCRIPTION OF THE PREFERRED EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

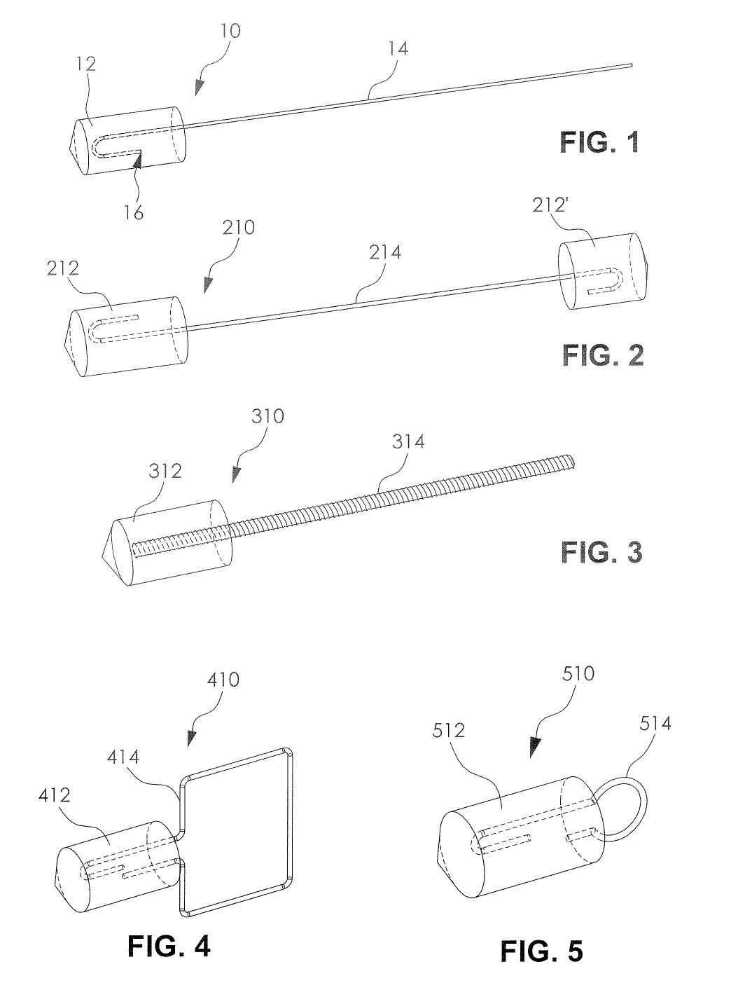

Referring to FIG. 1, there is illustrated a taxidermy mounting tool 10 which includes a plug 12 and a support means for posing 14.

The plug 12 is formed around an end 16 of the support means 14. The plug 12 is substantially cylindrical in shape with a substantially circular cross-section. It is understood that the plug 12 may have any shape such as cubic, rectangular solid, ovoid, spherical, or pyramidal, for example, as desired. It is also understood that the plug 12 may be rounded or formed with a point on an end thereof. Further, the plug 12 may have any cross-sectional shape such as square, rectangular, or triangular, for example, as desired. The plug 12 is formed from a casting material such as a plaster. The plug 12 may be formed from any conventional material such as a plastic, a clay, a metal, a ceramic, a wax, or other formable material, as desired.

While only one plug 12 is shown on the taxidermy mounting tool 10 of FIG. 1, FIG. 2 illustrates a mounting tool 210 including a first plug 212 formed around an end of a support means 214 thereof and a second plug 212′ formed around another end of the support means 214. As shown in FIG. 2, the plugs 212, 212′ have different lengths. It is understood that the plugs 212, 212′ may be formed from different materials or have different shapes and cross-sectional shapes, as desired.

As shown in FIG. 1, the support means 14 includes the end 16 forming a hook adapted to militate against the removal of the support means 14 from the plug 12. The support means 14 of FIG. 1 is an elongate wire. The wire may have any length and gauge, as desired. The support means 14 may he formed from any pliable material, such as a metal, a plastic, or a combination thereof, for example, as desired. As shown in FIG. 3, a support means 314 of a mounting tool 310 is formed from a rod. The rod may be an unthreaded rod or a threaded rod, as desired. The support means 314 may be formed a pliable material or a non-pliable material, as desired.

As illustrated in FIG. 4, a plug 412 of a mounting tool 410 is formed around both ends of a support means 414, to form a loop formed from a pliable material, as described above. The loop formed by the support means 414 may have any size and shape, as desired. As illustrated in FIG. 5, a plug 512 of a mounting tool is formed around both ends of a support means 514 forms an eyelet. As illustrated in FIG. 5, a plug 612 of a mounting tool 610 is formed around an end of a first support means 614 and around an end of a second support means 614′.

FIGS. 7-14 illustrate different mounted specimens using various mounting tools 10 illustrated in FIGS. 1-6. The particular uses of the mounting tools 10 and the specimens with which they are used in FIGS. 7-14 are exemplary only are not intended to limit the scope of the invention in any manner.

FIG. 7 illustrates a mounted specimen as prepared by a taxidermist, including a duck mannikin 18 having: an aperture 20a adapted to receive the plug 12 of the taxidermy mounting tool 10 shown in FIG. 1 for the neck and head of the duck; an aperture 20b adapted to receive the plug of a taxidermy mounting tool for a wing of the duck, such as the mounting tool 410 or the mounting too 10; an aperture 20c adapted to receive the plug of a taxidermy mounting tool for a leg of the duck; and an aperture 20d adapted to receive the plug of a taxidermy mounting tool for the tail of the duck. It is understood that any of the taxidermy mounting tools shown in FIGS. 1-6 may be used to support, pose, and mount the neck, wings, legs, and tail of the specimen, as desired.

FIG. 8 illustrates a turkey mannikin 818 having: an aperture 820a adapted to receive the plug of a desired taxidermy mounting tool for a wing of the turkey; an aperture 820b adapted to receive the plug of a desired taxidermy mounting tool for a leg of the turkey; and an aperture 820c adapted to receive the plug of a desired taxidermy mounting tool for the tail of the turkey. It is understood that any of the taxidermy mounting tools shown in FIGS. 1-6 may be used to support, pose, and mount the neck, wings, legs, and tail, as desired.

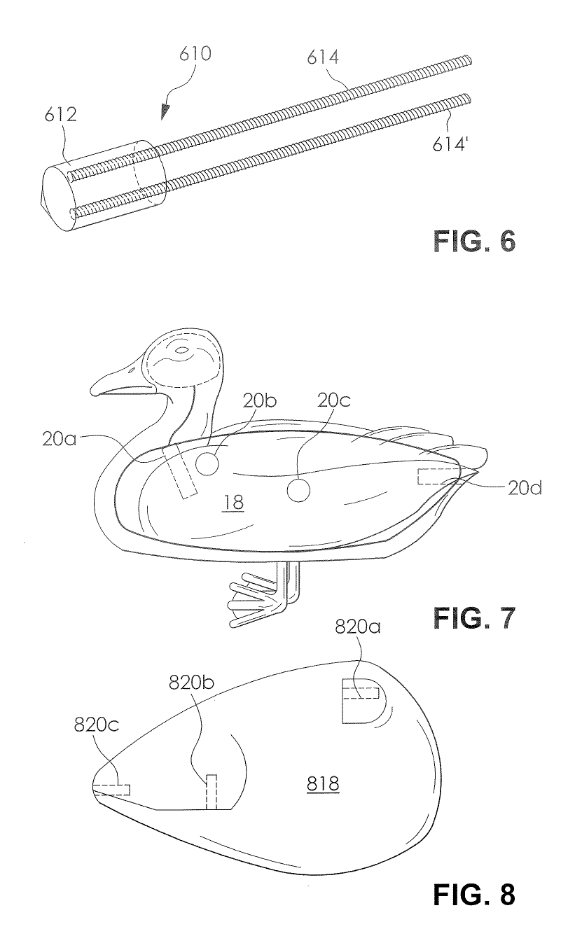

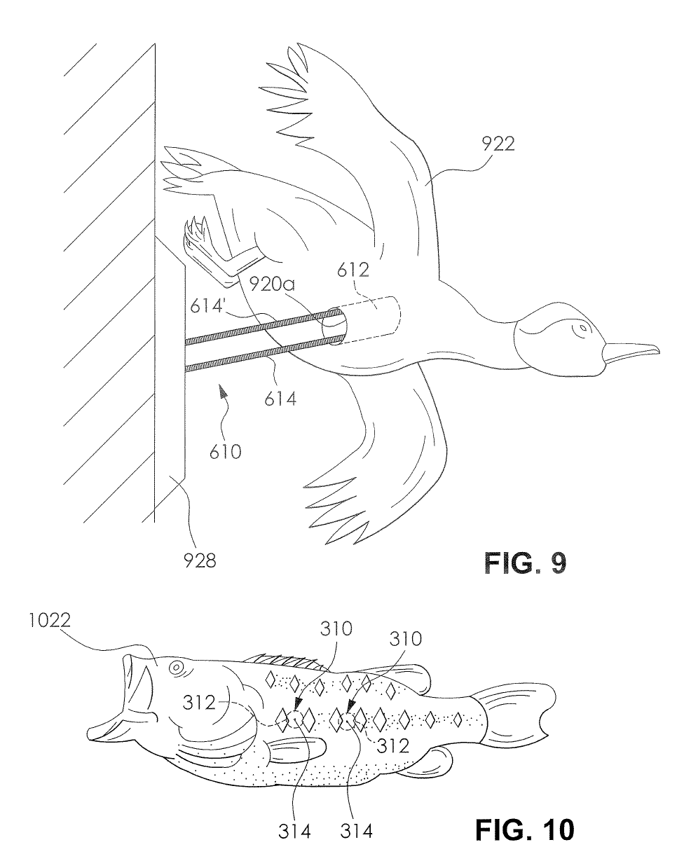

FIG. 9 illustrates a final mount 922 of a specimen, a flying bird, on a plaque 928. The final mount 922 includes the taxidermy mounting tool 610 of FIG. 6 fixed to a plaque 928 on a wall. The plug 612 of the mounting tool 610 is disposed in an aperture 920a to mount the specimen to the plaque 928. The support means 614, 614′ of the mounting tool 610 are adapted to mount the specimen to the plaque 928. It is understood that any of the mounting tools illustrated in FIGS. 1-6 may have been used to support, pose, and mount the neck, wings, legs, and tail, of the specimen in the desired flying pose prior to preparation of the final mount 922.

FIG. 10 illustrates a final mount 1022 of a specimen, a fish. The final mount 1022 includes a plurality of taxidermy mounting tools 310, as shown in FIG. 3 The taxidermy mounting tools 310 include plugs 312 formed around an end of the support means 314 formed from threaded rods adapted to mount the final mount 1022 to a base, plaque, plate, wall, as desired. The taxidermy mounting tool 610 as shown in FIG. 6 may also be used with the final mount 1022. It is understood that any of the mounting tools illustrated in FIGS. 1-6 may have been used to support, pose, and mount the head and tail of the specimen in a desired position prior to preparation of the final mount 1022.

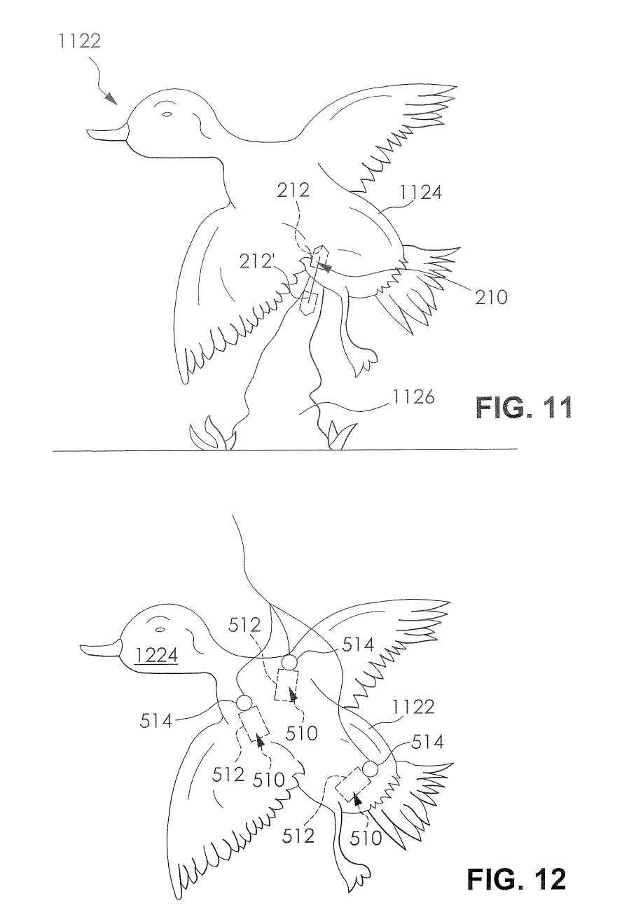

FIG. 11 illustrates a final mount 1122 including a specimen of a flying bird 1124 and a base 1126. The final mount 1122 includes the taxidermy mounting tool 210 of FIG. 2. The taxidermy mounting tool 210 includes a plurality of plugs 212, 212′. The plug 212 is disposed n an, aperture formed in the bird 1124 an he plug 212′ s is disposed in an aperture formed in the base 1126. It is understood that any of the mounting tools illustrated in FIGS. 1-6 may have been used to support, pose, and mount the neck, wings, legs, and tail, of the specimen in the desired flying pose prior to preparation of the final mount 1122.

FIG. 12 illustrates a final mount 1222 including a specimen, a flying bird 1224 and a plurality of taxidermy mounting tools 510 such as the tool 510 shown in FIG. 5. The plug 512 of each mounting tool 510 is disposed in an aperture formed in the back of the specimen. The support means 514 of each of the mounting tools 10 forms an eyelet adapted to receive a hanging means to facilitate hanging the final mount 1222 from a ceiling. It is understood that any of the mounting tools illustrated in FIGS. 1-6 may have been used to support, pose, and mount the neck, wings, legs, and tail, of the specimen in the desired flying pose prior to preparation of the final mount 1222.

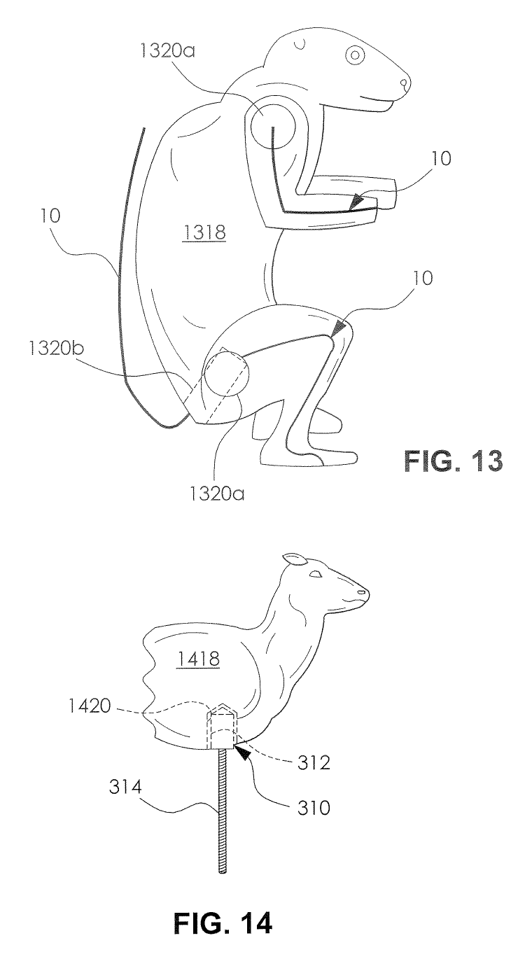

FIG. 13 illustrates a squirrel mannikin 1318 having a plurality of apertures 1320a adapted to receive the plugs 12 of a plurality of the taxidermy mounting tools 10 illustrated in FIG. 1 for the arms and legs of the squirrel, and an aperture 20b adapted to receive the plug 12 of the taxidermy mounting tool 10 for the tail of the squirrel. It is understood that any of the taxidermy mounting tools shown in FIGS. 1-6 may be used to support, pose, and mount the neck, arms, legs, and tail, as desired.

FIG. 14 illustrates a deer pedestal mannikin 1418. The mannikin 1418 includes the taxidermy mounting tool 310 as shown in FIG. 3. The taxidermy mounting tool 310 is disposed in an aperture 1420 disposed on a bottom of each of the mannikins 1418. The support means 314, extending from the plug 312 is adapted to be fixed to a base, plaque, or board. It is understood that any of the taxidermy mounting tools shown in FIGS. 1-6 may be used to support, pose, and mount the ears, jaw, and other appendages of the specimens, as desired.

As illustrated in FIGS. 7-14, the taxidermy mounting tools described herein and illustrated in FIGS. 1-6 may be used by a taxidermist to mount various animals such as ducks and other birds, fish, squirrels, and deer, for example. The plug of each taxidermy mounting tool is formed around at least one end of the support means using casting methods known in the art. An aperture having the substantially same diameter as the cross section of the plug is then formed into a mannikin. The aperture may be drilled to a desired depth based on the length of the support means or the length of the plug. Further, the diameter of the aperture may be smaller than the diameter of the cross section of the plug to facilitate a tighter fit of the plug in the aperture. The number and location of apertures formed in the mannikin will vary based on the desired pose of the specimen, the size of the specimen, and other considerations.

The taxidermist will then place the skin of the specimen over the manikin. The head, neck, tail, legs, or wings of the specimen may be disposed over the support means of the taxidermy mounting tool and wired as known in the art to obtain the appropriate pose. The head, neck, tail, legs, or wings of the specimen having the taxidermy mounting tool disposed therein is mounted to the manikin by disposing the plug in the aperture formed in the manikin. The taxidermy mounting tool may then be rotated or the support means may be manipulated to properly mount and pose the head, neck, tail, legs, or wings on the manikin.

The plug of the taxidermy mounting tool is adapted to be removed from the manikin without substantially damaging the manikin. Once the taxidermist has posed the specimen as desired, the plug is covered with an adhesive, repositioned in the aperture, and allowed to cure. Once the adhesive has cured, the final mount is prepared by fixing the specimen to a plate, plaque, base, or other type of stand, as desired.

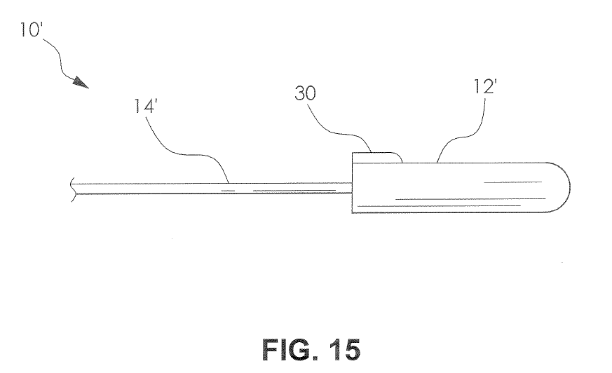

A mounting tool 10′ according to another embodiment of the invention is illustrated in FIG. 15. The structure of the mounting tool 10′ is similar to the structure of the mounting tool 10 of FIG. 1 except as described below. Like structure from FIG. 1 repeated in FIG. 15, FIG. 15 includes identical reference numerals accompanied by a prime (′) symbol.

The mounting tool 10′ includes a plug 12′ having an anchor 30 and a support means 14′. The anchor 30 is adapted to militate against the rotation of the plug 12′ in an aperture formed in a specimen. The anchor 30 is formed on an outer wall of the plug 12′ adjacent an exposed portion of the support means 14′. The anchor 30 may be formed anywhere on the plug 12′, as desired.

The anchor 30 has a substantially cylindrical shape and a circular cross-section, but the anchor 30 may have any shape and any cross-section, as desired. It is understood that the anchor 30 may have any shape such as cubic rectangular solid, ovoid, spherical or pyramidal, for example, as desired. It is also understood that the anchor 30 may be rounded or formed with a point on an end thereof. Further, the anchor 30 may have any cross-sectional shape such as square, rectangular, or triangular, for example, as desired. The anchor 30 is integrally formed with the plug 12′ from a casting material such as a plaster during a casting process. The anchor 30 and the plug 12′ may be formed from any conventional material such as a plastic, a metal, a ceramic, a wax, or other formable material, as desired. It is understood that the anchor 30 may be formed separately from the plug 12′ and adhered thereto. It is also understood that a plurality of anchors 30 may be formed on the plug 12′.

The plug 12′ is formed around an end of the support means 14′ using casting methods known in the art. An aperture having the substantially same diameter as the cross section of the plug 12′ is then formed into a specimen mannikin. The aperture may drilled to a desired depth based on the length of the support means 14′ or the length of the plug 12′. Further, the diameter of the aperture may be smaller than the diameter of the cross section of the plug 12′ to facilitate a tighter fit of the plug 12′ in the aperture. The number and location of apertures formed in the mannikin will vary based on the desired pose of the specimen, the size of the specimen, and other considerations.

The taxidermist will then place the skin of the specimen over the mannikin. The head, neck, tail, legs, or wings of the specimen may be disposed over the support means 14′ of the taxidermy mounting tool 10′ and wire as known in the art to obtain the appropriate pose. The head, neck, tail, legs, or wings of the specimen having the taxidermy mounting tool 10′ disposed therein is mounted to the mannikin by disposing the plug 12′ in the aperture formed in the mannikin up to the anchors 30 without disposing the anchors 30 therein. The appendage is then rotated and manipulated to a desired configuration and the plug 12′ and the anchors 30 are then pressed into the aperture. Because the anchors 30 militate against the rotation of the plug 12′ in the aperture, if the appendage configuration requires adjustment, the anchors 30 must be completely removed from the aperture to facilitate adjustment and rotation thereof. The plug 12′ of the taxidermy mounting tool 10′ is adapted to be removed from the mannikin without substantially damaging the mannikin. Once the taxidermist has finalized the pose of the specimen as desired, the plug 12′ and the anchor 30 is covered with an adhesive, re-positioned in the aperture, and allowed to cure. Once the adhesive has cured, the final mount is prepared by fixing the specimen to a plate, plaque, base, or other type of stand, as desired.

From the foregoing description, one ordinarily skilled in the art can easily ascertain the essential characteristics of this invention and, without departing from the spirit and scope thereof, can make various changes and modifications to the invention to adapt it to various usages and conditions in accordance with the scope of the appended claims.

What is claimed is:

1. A taxidermy tool for mounting a mannikin comprising:
a support means for posing having spaced apart ends; and
a plug formed at one end of said support means adapted to be received in an aperture formed in a mannikin, wherein said support means may be selectively manipulated to obtain a desired orientation.

2. The mounting tool defined in claim 1, including at least one anchor formed on said plug and adapted to militate against the relative rotation of said plug in the aperture formed in the mannikin.

3. The mounting tool defined in claim 1, wherein said plug is formed from one of a plaster, a plastic, a clay, a metal, a ceramic, and a wax.

4. The mounting tool defined in claim 1, wherein said plug terminates in a point.

5. The mounting tool defined in claim 1, wherein said plug is cylindrical in shape.

6. The mounting tool defined in claim 1, wherein said support means is formed from a pliable material.

7. The mounting tool defined in claim 1, wherein said support means is formed from a non-pliable material.

8. The mounting tool defined in claim 1, including a plug is formed at the other end of said support means

9. The mounting tool defined in claim 8, wherein said plug and said support means cooperate to form an eyelet.

10. A taxidermy tool for mounting a mannikin comprising:
a support means for posing the mannikin having spaced apart ends;
a plug formed at one end of said support means adapted to be received in an aperture formed in the mannikin; and
at least one anchor formed on said plug and adapted to militate against the relative rotation of said plug in the aperture, wherein said support means may be selectively manipulated.

11. The mounting tool defined in claim 10, wherein said support means is formed from a pliable material.

12. The mounting tool defined in claim 10, wherein said support means is formed from a non-pliable material.

13. The mounting tool defined in claim 10, wherein said plug and said anchor are formed from one of a plaster, a plastic, a clay, a metal, a ceramic, and a wax.

14. The mounting tool defined in claim 10, wherein said plug terminates in a point.

15. The mounting tool defined in claim 10, wherein said anchor is cylindrical in shape.

16. A method of performing a taxidermy procedure comprising the steps of:
providing a mannikin of a desired specimen having at least one aperture formed therein;
providing a taxidermy mounting tool including a support means the mannikin with a plug disposed on an end thereof;
disposing the skin of the specimen over the mannikin;
disposing one of a neck, a leg, an arm, and a tail over the support means of the taxidermy mounting tool;
manipulating the support means to obtain a desired orientation of one of the neck, the leg, the arm, and the tail;
disposing the plug of the taxidermy mounting tool in the aperture of the mannikin;
adjusting the taxidermy mounting tool to obtain the desired pose of the specimen; and
fixing the plug in the aperture of the mannikin to maintain the desired pose.

17. The method of claim 16, wherein the plug includes an anchor adapted to militate against the relative rotation of the plug in the aperture formed in the mannikin.

18. The method of claim 16, further including the step of disposing the plug of the taxidermy mounting tool in the aperture of the mannikin, adjusting the mounting tool to obtain the desired pose of the specimen, and pressing the plug and anchor into the mannikin.

19. The method of claim 16, wherein the plug is at both of the spaced apart ends of the support means.

20. The mounting tool of claim 19, wherein the plug and the support means cooperate to form an eyelet.
